(19) United States
(12) Patent Application Publication
(10) Pub. No.: US 2017/0048122 A1
(43) Pub. Date: Feb. 16, 2017

(54) METHOD AND DEVICE FOR DIAGNOSING TRANSMISSION INTERFERENCE IN A NETWORK ACCORDING TO THE OPC UA STANDARD

(71) Applicant: SIEMENS AKTIENGESELLSCHAFT, 80333 München (DE)

(72) Inventors: SVEN KERSCHBAUM, Fürth (DE); MATTHIAS HELLER, Nürnberg (DE); FRANK VOLKMANN, Nürnberg (DE)

(73) Assignee: SIEMENS AKTIENGESELLSCHAFT, 80333 München (DE)

(21) Appl. No.: 15/305,881

(22) PCT Filed: Apr. 23, 2014
(86) PCT No.: PCT/EP2014/058191

§ 371 Date: Oct. 21, 2016

(51) Int. Cl. H04L 12/26; H04L 12/721

(52) U.S. Cl. CPC H04L 43/0823; H04L 45/32; H04L 43/50

(57) ABSTRACT

A method for diagnosing transmission interference in a data network, where the data network includes first network elements which transmit and/or receive first data packets according to a data transmission standard for implementing real-time communication, and second network elements which do not or do not only transmit and/or receive second data packets according to said data transmission standard. Diagnostic data packets are introduced into the data network. A path of the diagnostic data packets through the data network is determined. The data network is flooded with the diagnostic data packets. The diagnostic data packet is transmitted from the first network element to the second network element. Whether second network element receives the diagnostic data packet is determined. When there is interference, all network element ports through which the diagnostic data packet passes are determined. A mark that indicates potential transmission interference is applied to the determined network element ports.

PROFINET (Process Field Network) is the open industrial Ethernet standard from Profibus & Profinet International (PI) for automation. PROFINET uses TCP/IP and IT standards, has real-time Ethernet capability and makes it possible to integrate field bus systems. It is an industrial protocol with real-time capability which has become very widespread in the meantime for transmitting process data.

A distinction is made between PROFINET IRT (Isochronous-Real-Time) and RT (Real-Time). In contrast with RT, PROFINET IRT provides hard real-time capability.

PROFINET IRT communication consists of an isochronous real-time communication portion and a non-real-time communication portion (NRT). The IRT portion is preplanned by allocating time slots to different transmitters. However, this time range does not fill 100% of the available time range (per cycle). The remainder can be used for NRT traffic.

IRT communication is distinguished, inter alia, by the following features: The data are transmitted at equidistant intervals of time. Each interval of time is subdivided into an IRT interval (IRT channel) and an open interval (open channel). Time synchronization is carried out at the start of each interval of time. An IRT frame is characterized by its temporal position inside the IRT channel. In the case of IRT, the time synchronization is carried out with the aid of the Precision Transparent Clock Protocol (PTCP) or PTP (according to IEEE 1588). Special IRT switches are needed to ensure the temporal requirements. As a result of the time synchronization, all switches are informed of the time for starting to guide through IRT messages.

When using PROFINET IRT, the engineering tool used (for example the so-called TIA Portal offered by Siemens) stipulates the transmission of the process data according to an exact, stipulated sequence with the highest precision in advance offline for the entire network (all IRT subscribers). The maximum permitted deviation from the start of a bus cycle is 1 μs. Therefore, no waiting times result during communication. For this data transmission trimmed to the highest performance, special PROFINET IRT hardware precautions must be taken, in particular Ethernet controllers which are suitable for assisting with the clock synchronization.

The preplanning in the IRT portion and the monitoring by the IRT hardware preclude the IRT communication portion being interfered with by NRT.

On communication paths which do not require any IRT communication, the network can be combined with standard network components; PROFINET RT does not presuppose any special hardware. PROFINET RT communication can be used on these communication paths.

As a result, however, no preplanning is carried out either since this would presuppose monitoring of the time slices by the hardware. Rather, PROFINET RT uses the standard mechanisms defined by IEEE 802.3. As a result, PROFINET RT can coexist with standard Ethernet communication (NRT) and associated hardware. RT communication must be transmitted with priority over standard communication so that RT communication can meet real-time requirements—it goes without saying that these requirements do not go as far as in IRT. This preference is achieved by using the priority levels of the Ethernet.

Since the separation between RT and NRT communication in PROFINET RT is not as effective as in PROFINET IRT, requirements must be imposed on NRT communication even though these requirements are not required by IEEE 802.3.

PROFINET requires all subscribers to transmit no more than 3 Kbyte/ms. In contrast, there is no such requirement in IEEE 802.3; rather, there are a plurality of extensions which are an obstacle to this requirement, for example the so-called burst mode transmission or jumbo frames, that is to say frames which are not standardized and are excessively large.

This may now result in RT frames being rejected on account of overflowing queues in the network elements since the network component is blocked, for example, by jumbo frames of NRT communication which have just been transmitted. RT communication can then no longer be maintained, with the result that the subordinate automation task can consequently no longer be carried out without errors. It is difficult to diagnose this problem in the real network since the diagnostic possibilities in the network (for example by means of SNMP—Simple Network Management Protocol) are too sluggish for this purpose.

In one case, a PROFINET RT network was set up for the purpose of transmitting the real-time data in an industrial installation. Over the course of the installation lifetime, the installation was expanded, in a maintenance situation, with components for transmitting screen contents via VNC (Virtual Network Computing). VNC is generally known software which displays the screen contents of a remote computer (server) on a local computer (client) and, in return, transmits keyboard and mouse movements of the local computer to the remote computer. This resulted in the installation sporadically stopping, associated with high costs for the customer. The reason for the standstill was the burst-like transmission of the screen contents which resulted in the loss of RT frames at a network component.

High costs arise as a result of the diagnosis or the finding of the cause of the interference proving to be difficult and time-consuming. In order to find the cause, network protocols were recorded at various points in the network over a relatively long time during operation and SNMP analyses were produced. Since SNMP information, for example packet losses and bandwidth, is cyclically averaged over a relatively long interval of time, bursts which have occurred can no longer be perceived as such. They are “blurred” over a plurality of recordings. With the aid of network recording tools, for example Wireshark and SNMP clients, an attempt is thus made to understand the behavior on the network.

The extended requirements of PROFINET RT cannot be recognized by the system (network itself). Furthermore, the standard software/hardware, for example VNC or video cameras, only heeds the compliance with the standard Ethernet (IEEE 802.3) requirement, but not the compliance with the IRT requirements.

The problem was previously noticed only when perceived by the operator of the installation (installation standstill) and was analyzed in order to eliminate the fault or the interference source. If the installation is in the production phase, changes to the network cannot be expected, with the exception of introducing additional devices for maintenance and diagnosis. The highest costs are not caused by the first one-off occurrence of the problem, but rather by the time-consuming diagnosis for finding the interference source.

Therefore, the object of the invention is to specify a method which makes it possible to determine as quickly as possible where the interference source is located.

The object is achieved by means of a method according to patent claim 1.

The method for diagnosing transmission interference in a data network, the data network comprising at least one first class of network elements which transmit and/or receive data packets only according to a data transmission standard for implementing real-time communication, in particular the PROFINET RT standard, and a second class of network elements which do not or do not only transmit and/or receive data packets according to a data transmission standard for implementing real-time communication, is distinguished by the fact that diagnostic data packets are introduced into the data network in a targeted manner and the data network is flooded with diagnostic data packets in a targeted manner such that utilization of the data network of virtually 100% is achieved.

The object is also achieved by means of a device according to patent claim 10 for carrying out the method according to patent claim 1.

Since, if the problem occurs, PROFINET RT packets having a high priority are rejected, all packets with a lower priority are also rejected, in particular.

For the rapid diagnosis, the network is flooded with packets of the lowest priority, that is to say precisely such that virtually 100% of the network is utilized. This flooding happens in a directed manner between a set of subscribers. The packets “know” their path and contain a counter which is unique for each diagnostic data packet transmitted and thus makes it possible to determine how many and which data packets are lost.

If packet losses now occur, the presence of a problem can be determined immediately after the problem occurs and without a further loss of time. Further analysis of the missing diagnostic data packets, advantageously by means of the counters contained in the diagnostic data packets, makes it possible to detect the network components in which the packet loss occurred.

If a plurality of failure points have been found, the path covered by the diagnostic data packets having interference can be thereby inferred, at least the first and last switches, and the interference source can therefore be ultimately identified with a high degree of certainty according to the claimed method.

In the following exemplary embodiment which should not be understood as being restrictive, the analysis of the radio cross-measurement is stated in pseudocode, by way of example:
1 Initialization of the set of ports having interference: S={ }
2 For each communication connection of the cross-measurement (start, destination):
3 Does the start->destination communication connection have interference?
4 IF yes, there is interference:
5 Add all ports which forward packets in the communication connection from the start to the destination to the set of ports S having interference since there may potentially be interference on these ports.
6 ELSE no, no interference:
7 Remove all ports which forward packets in the communication connection from the start to the destination from the set of ports S having interference since there may be no interference on these ports with a very high degree of probability.
8 Set of the ports S having interference now contains all ports having interference. The devices having interference can therefore be immediately inferred on the basis of the ports.

This method advantageously immediately detects the packet losses occurring in the network and simultaneously detects the causing interference source(s).

This avoids the time-consuming search for the interference source which produces the greatest monetary losses as a result of long-term failures of the data network.

The rapid identification of the interference source also makes it possible to quickly exclude other components suspected of being the cause.

The invention is represented below by means of Figures:

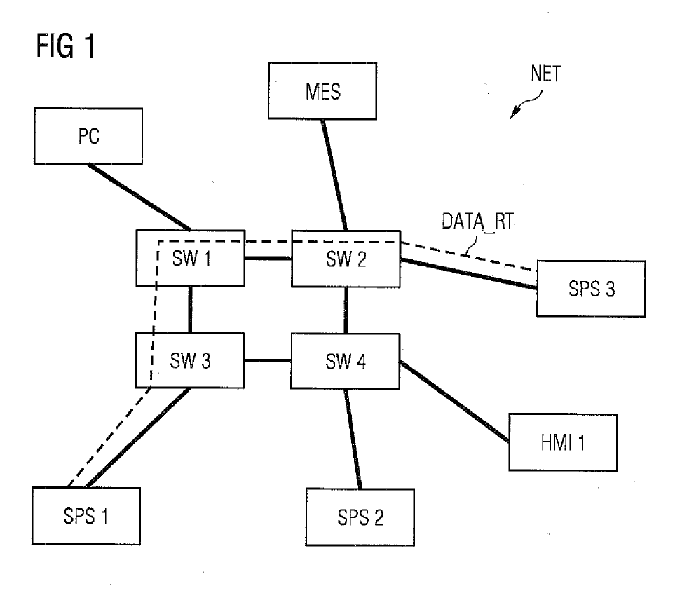

FIG. 1 shows a functioning network structure from today's point of view with PROFINET RT,

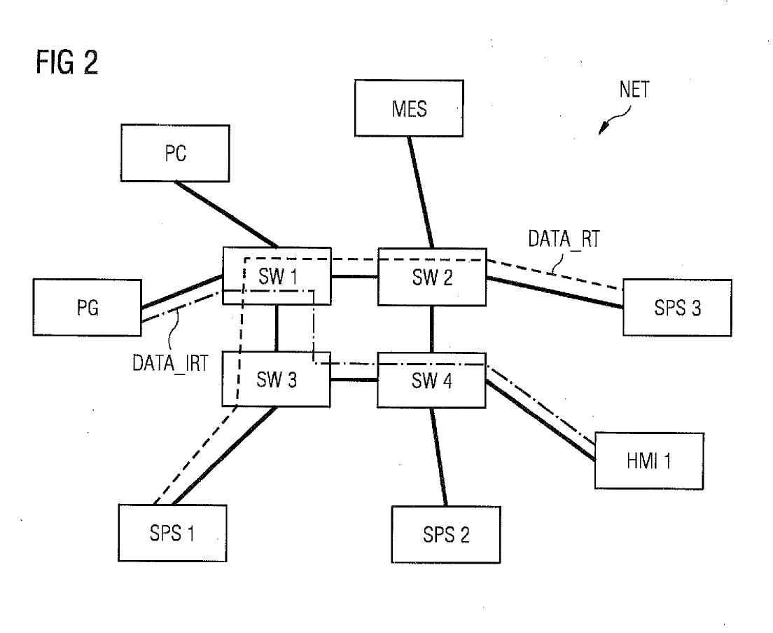

FIG. 2 shows a maintenance production device introduced into the network structure from FIG. 1 with VNC communication (screen transmission) from the HMI1 to the production device,

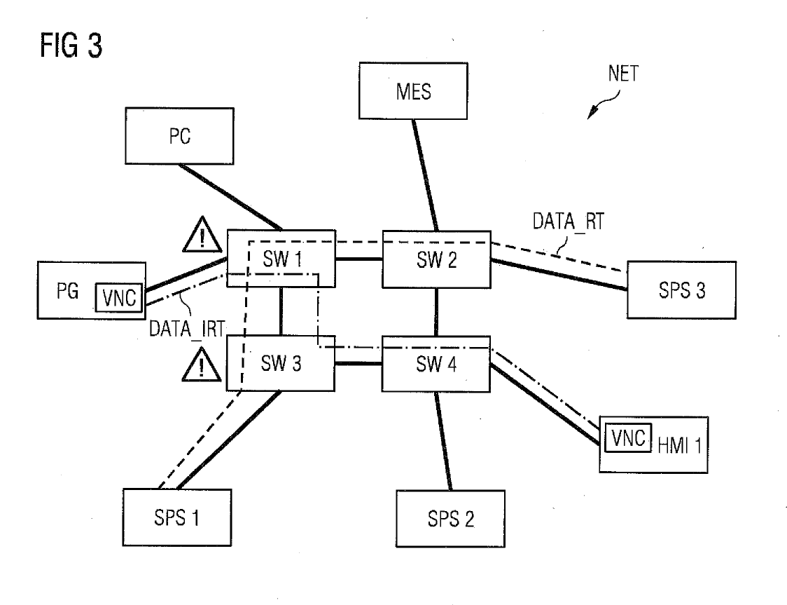

FIG. 3 shows the VNC data transmission from FIG. 2 which results in the interference with the RT traffic, and

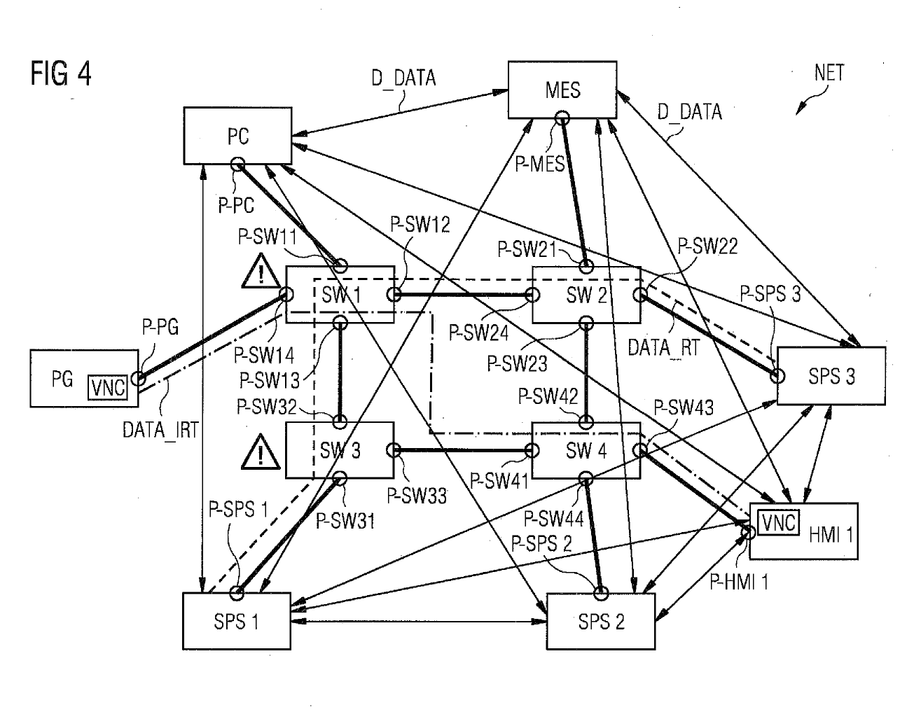

FIG. 4 shows the detection of the interference by means of “cross-measurement” according to the claimed method.

In this case, the data network NET consists of a plurality of switching nodes SW1-SW4 (also called switch) which are connected to one another. The further connected network elements interchange data via these network elements. In the example illustrated in FIG. 1, these are a plurality of programmable logic controllers SPS1-SPS3 of an automation system, as well as a Manufacturing Execution System MES, an operator interface (Human Machine Interface) HMI1 and a further device PC. Two of the programmable logic controllers SPS1 and SPS3 interchange data packets DATA_RT and the path of the data packet inside the network is clear, as follows: SW2-SW1-SW3.

In FIG. 2, a further network device PG is now introduced into the data network already described in FIG. 1, for example in order to carry out maintenance work due in the underlying automation system. This further network device likewise transmits data traffic DATA_IRT via a further defined path inside the network: SW1-SW3-SW4.

In one example, the Virtual Network Computing, VNC for short, is now used. This is software which displays the screen contents of a remote computer (server) on a local computer (client) and, in return, transmits keyboard and mouse movements of the local computer to the remote computer. It is therefore possible to work on a remote computer as if sitting directly in front of it. FIG. 3 now illustrates that an unusually large number of unplanned data packets are transmitted in a burst-like manner on account of the VNC since an unexpected event has occurred.

Since the network elements SW1 and SW3 must handle both the regular data traffic between SPS1 and SPS3 and the data packets produced by the VNC, interference occurs here in the data transmission.

On the basis of the situation depicted in FIG. 3, FIG. 4 now shows how the entire network NET is flooded with diagnostic data packets D_DATA by means of the method according to the invention. In addition, the respective network elements are advantageously also illustrated and distinguished with additional data ports P-PC, P-MES, P-etc., that is to say additional addressing attributes.

It can be seen, for example, that the data traffic of the VNC protocol, DATA_IRT, is passed via port P_SW33 in the network element SW3, whereas the other data traffic DATA_RT is forwarded via port P_SW31.

The following example is based only on the network elements, but not on the port information.

The table now shows the “flooding” connections on which packets are lost. In this case, only the respective end points of the connections, that is to say the transmitter and receiver, are listed in this table.

| | to | | | | | |
|---|---|---|---|---|---|---|
| from | PC | MES | SPS3 | HMI1 | SPS2 | SPS1 |
| PC | ∘ | | | x | x | x |
| MES | | ∘ | | x | x | x |
| SPS3 | | | ∘ | x | x | x |
| HMI1 | | | | ∘ | | |
| SPS2 | | | | x | ∘ | |
| SPS1 | | | | x | x | ∘ |

It can now be concluded from this table and the knowledge of the underlying data network that the network elements/switches SW1, SW3 and SW4 (which are not included in the table) are affected.

If the PC-MES connection is considered, the connection does run via the switch SW1 which is actually affected, but transmitting and receiving ports other than of the “interference source” are used here, with the result that this connection is not picked up as having interference.

Assuming that the switches have a transmission queue for each port, a transmission direction also additionally results, from which it can be concluded that the interference source must be connected to SW1 and the interference sink must be the HMI panel.

This can be discerned from the fact that the table is not symmetrical: the connection from PC to HMI1 is therefore marked as having interference, but the return path from HMI1 to PC is not.

With this information, it is certain that the interference source must be either the PC1 or the production device. On closer consideration with the aid of SNMP (Simple Network Management Protocol) at the switch SW1, the network element PG can now be uniquely identified as the cause of the interference.

The analysis of the results table for the radio cross-measurement can also be evaluated in an automated manner by means of a program. The analysis algorithm was already stated further above in the form of pseudocode.

### LIST OF REFERENCE SYMBOLS

DATA_NRT Non-real-time data
DATA_RT Real-time data
F Filter
HMI1 Human machine interface
HW AP Hardware PROFINET access plug
MES Manufacturing execution system
NET Network
P- . . . Communication port of a network element
PC Personal computer
PG Production device
SW2, 3, 4 Switch
SPS1, 2, 3 Programmable logic controller
S Memory

What is claimed is:

1.-11. (canceled)

12. A method for diagnosing transmission interference in a data network, the data network including first network elements which transmit and/or receive first data packets only according to a data transmission standard for implementing real-time communication, and second network elements which do not or do not only transmit and/or receive second data packets according to said data transmission standard, said method comprising:
introducing diagnostic data packets into the data network in a targeted manner;
determining a path of the diagnostic data packets through the data network;
flooding the data network with the diagnostic data packets in a targeted manner so as to achieve 100% utilization of the data network;
transmitting the diagnostic data packet from the first network element to the second network element;
determining whether the diagnostic data packet is received by the second network element;
when the diagnostic data packet has interference, determining all network element ports through which the diagnostic data packet passes on the way from the first network element to the second network element; and
applying a mark that indicates potential transmission interference to the determined network element ports.

13. The method of claim 12, wherein the data transmission standard is a PROFINET RT standard.

14. The method of claim 12, wherein the diagnostic data packets are not transmitted or not only transmitted according to the data transmission standard for implementing real-time communication.

15. The method of claim 12, further comprising carrying out an evaluation on the basis of diagnostic data packets in order to detect a network component causing the transmission interference.

16. The method of claim 15, wherein the diagnostic data packets are received diagnostic data packets.

17. The method of claim 15, wherein the diagnostic data packets are lost diagnostic data packets.

18. The method of claim 15, wherein the diagnostic data packets contain a first data field with a unique counter in each case, a second data field with a starting address, and a third data field with a destination address.

19. The method of claim 17, further comprising determining at least two network components which result in a loss of the diagnostic data packets on the path covered by the diagnostic data packets when detecting the network component causing the transmission interference.

20. The method of claim 17, further comprising determining at least two paths when detecting the network component causing the transmission interference, and forming an intersection on the basis of the determined paths.

21. The method of claim 12, further comprising, in the absence of an interference of the diagnostic data packet, determining the network element ports through which the diagnostic data packet passes on the way from the first network element to the second network element, checking whether the network element ports have the mark that indicates potential transmission interference, and removing the mark when present.

22. The method of claim 21, further comprising determining a network element having interference on the basis of the network element ports having the mark that indicates potential transmission interference.

23. The method as in claim 12, wherein the data packets are transmitted via the data network according to the OPC UA standard.

24. A device for diagnosing transmission interference in a data network, the data network comprising at least first network elements which transmit and/or receive data packets only according to a data transmission standard for implementing real-time communication, and second network elements which do not or do not only transmit and/or receive data packets according to said data transmission standard, said device configured to:
introduce diagnostic data packets into the data network in a targeted manner,
determine a path of the diagnostic data packets through the data network,
flood the data network with the diagnostic data packets in a targeted manner so as to achieve 100% utilization of the data network,
transmit the diagnostic data packet from the first network element to the second network element,
determine whether the diagnostic data packet is received by the second network element,
when the diagnostic data packet has interference, determine all network element ports through which the diagnostic data packet passes on the way from the first network element to the second network element, and
apply a mark that indicates potential transmission interference to the determined network element ports.

25. The device of claim 23, wherein the data transmission standard is a PROFINET RT standard
